(19) United States
(12) Patent Application Publication
(10) Pub. No.: US 2005/0242255 A1
(43) Pub. Date: Nov. 3, 2005

(54) Triangular Universal Attachment System

(75) Inventors: Alan Sturt, West Bloomfield, MI (US); Michael James VanNieuwkuyk, Brownstown, MI (US)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/709,404

(22) Filed: May 3, 2004

(51) Int. Cl. G01L 3/26; F16B 45/00

(52) U.S. Cl. 248/304

(57) ABSTRACT

Disclosed is a universal triangular mounting unit in-vehicle attachment system apparatus comprising open slots whereby a similarly shaped storage unit with complimentary prongs is inserted, providing a secure and easy fastening attachment device designed to secure devices and items in place within the vehicle such as, for example, cellular phones, CDs or DVDs, bottles, mugs, cups, coolers, bike racks, and PDAs. This in-vehicle storage or securing attachment system can be molded to conform directly to the size and shape of the particular object or, alternatively, a more generic type receptacle can be used to secure such items. Further, the in-vehicle attachment system is incorporated into the vehicle, with multiple locations, including the seat back panel, instrument panel, door panel, quarter panel, floor panel, or other interior surfaces.

### BACKGROUND OF INVENTION

1. Field of the Invention

The present invention generally relates to an item securing system that is adaptable to hold a variety of items in a secure and user accessible manner within a vehicle. The present invention further relates to an item securing system that allows stored devices to be transferred between several vehicles equipped with the present invention.

2. Description of the Related Art

Consumers are continually seeking more efficient, convenient, versatile and secure ways to transport or store contents which are stowed or utilized in a motor vehicle such as a van, minivan, and passenger sedan and sport utility vehicle. Conventional methods of stowing items within the vehicle have been trunk space, the floor of the vehicle, the area behind the seats, and pre-formed brackets such as cup holders, change holders, and the like.

For example, U.S. Pat. No. 4,418,733 issued Dec. 6, 1983 to Kallman teaches the use of hook and loop materials for attaching receptacles such as beverage holders, pouches and the like to a surface on or in a vehicle.

U.S. Pat. No. 4,708,549 issued Nov. 24, 1987 to Jensen teaches a bolt down anchor fitting for use in tracks in vehicles and aircraft for example where heavy loads such as cargo containers and passenger occupied seating must be secured and not be prone to vibration loosening.

U.S. Pat. No. 5,139,375 issued Aug. 18, 1992 to Franchuk teaches a bolt down bar rail system allowing for mounting of tie-downs, racks and other devices to the open bed of a truck.

U.S. Pat. No. 5,255,832 issued Oct. 26, 1993 to Christensen teaches a rail mounting system for use in truck beds to allow for mounting equipment such as tool boxes.

U.S. Pat. No. 5,642,845 issued Jul. 1, 1997 to Van Kooten teaches a permanently mounted tool box locking device for use in truck beds.

U.S. Pat. No. 5,653,366 issued Aug. 5, 1997 to Liserre teaches a mounting means for mounting a security box to the floor of a vehicle.

U.S. Pat. No. 5,730,346 issued Mar. 24, 1998 to Adams et al teaches a strap and mounting block assembly to allow the attaching of cargo alongside a vehicle or building. The assembly requires the use of mounting brackets being permanently attached to the building or vehicle.

U.S. Pat. No. 5,769,294 issued Jun. 23, 1998 to Heinz et al teaches a recessed accessory hook for use on the interior of a vehicle.

U.S. Pat. No. 6,349,865 issued Feb. 26, 2002 to Tolley et al teaches a collapsible pouch-like storage container for securing objects in the bed of a truck. The storage container is fixedly attached to the truck bed.

U.S. Pat. No. 6,547,117 issued Apr. 15, 2003 to Glovatsky et al teaches a beverage container holder for use in vehicles that utilizes a sensor and continuous moldline technology which changes shape to grip a container placed in the holder.

U.S. Pat. No. 6,550,654 issued Apr. 22, 2003 to Crago teaches a removable cargo net for use in a vehicle which utilizes a permanently mounted frame member to receive and hold net retainers located around the periphery of the net.

U.S. Patent Application Publication Number 2001/0054632 published Dec. 27, 2001 to Larsen et al teaches an apparatus that can be clamped to the floor attachments of a motor vehicle used to secure removable seats. The securing of the apparatus to the floor attachments is accomplished by pincers that lock around the floor attachment bars.

With consumer spending more time in their vehicles than ever-before, the tendency or need to have personal items in the vehicle is more prevalent. For example, more drivers and passengers carry mobile phones, coffee mugs, CDs and DVDs in their vehicles. However, storage and secure retention of such items has routinely been a concern for consumers. In addition, there is an ever-growing concern about leaving such devices as well as PDAs and the like in open view when the vehicle is not occupied.

Accordingly, there is a need for a attachment and storage system for such items that provides secure safe storage while allowing use of the secured devices by drivers and passengers while occupying the vehicle.

### DISCLOSURE OF THE INVENTION

The present invention provides advantages and alternatives over the prior art by providing a universal, in-vehicle attachment system comprising at least one open cavity wherein any item equipped with at least one complimentary prong can be inserted, providing a secure and easy fastening attachment device. The present invention may be designed to secure devices and items in place within the vehicle such as, for example, cellular phones, CDs or DVDs, bottles, mugs, cups, coolers, bike racks, and PDAs. Further the storage or securing device can be molded to conform directly to the size and shape of the particular object or, alternatively, a more generic type receptacle can be used to secure such items.

According to a further aspect of the present invention, there is provided an in-vehicle attachment system designed and incorporated into the vehicle, with multiple locations, including the seat back panel, instrument panel, door panel, quarter panel, floor panel, or other interior surface. Additionally, the storage units may be transferred between vehicles having the in-vehicle attachment system of the present invention without vehicle specific storage containers.

According to yet another aspect of the present invention there is provided a device mounting apparatus suitable for mounting items in a vehicle comprising in cooperative combination: a universal mounting unit mounted in an interior panel or floor of a vehicle having located therein at least one mounting cavity; a storage receptacle having located thereon at least one prong suitable for inserting into said at least one mounting cavity; thereby allowing the mounting of a desired device in a vehicle.

The present invention thus advantageously provides a universal device attachment and storage system that is easy to use, cost effective and in which the storage units themselves may be used in multiple vehicles without special adapters or modifications.

### BRIEF DESCRIPTION OF DRAWINGS

FIG. 1 shows a bottom perspective view of one embodiment of the triangular portion of the universal attachment system of the present invention.

FIG. 2 shows a top perspective view of one embodiment of the triangular portion of the universal attachment system of the present invention.

FIG. 3 shows a partial perspective view of one embodiment of the attachment system of the present invention mounted in an interior panel of a vehicle with the plane side showing.

FIG. 4 show a partial perspective view of one embodiment of the attachment system of the present invention mounted in an interior panel of a vehicle with the slot side showing and ready for use.

FIG. 5 shows a partial perspective view of one embodiment of the attachment system of the present invention mounted in an interior panel of a vehicle with the hook side showing and ready for use.

FIG. 6 shows a perspective view of one embodiment of a storage receptacle of the present invention.

FIG. 7 show a bottom perspective view of another embodiment of the triangular portion of the universal attachment system of the present invention.

### DETAILED DESCRIPTION

Reference will now be made to the drawings, wherein to the extent possible like reference numerals are utilized to designate like components throughout the various views. Referring to FIG. 1, there is presented a bottom perspective view of a preferred embodiment of the triangular universal mount unit 10 of the present invention comprising a triangular universal mount unit 10, preferably formed of a molded plastic, and having a closed position side 1 (FIG. 2), an open use position side 2 having a mounting section 3 containing at least one vertical mounting cavity 4 therein, and a second open use position side 5 having a hook unit 6, an open face 7 and a closed face 8 (FIG. 2).

As further shown in FIG. 1 there is shown the open face 7 and a mounting device retaining sleeve 9 and having a bore 11 therein, both being dimensioned for receiving and retaining a mounting device (not shown). Suitable mounting devices include, for example, pins, screws, and rivets and are well known in the art.

FIG. 2 presents a top perspective view of the embodiment of the triangular universal mount unit 10 shown in FIG. 1 having a closed position side 1, an open use position side 2 having a mounting section 3 containing at least one vertical mounting cavity 4 therein, and a second open use position side 5 having a hook unit 6, and open face 7 (Figure) and a closed face 8 having located therein a bore 11.

The in-vehicle attachment system of the present invention may be incorporated into the vehicle, with multiple locations, including the seat back panel, instrument panel, door panel, quarter panel, floor panel, and other interior surfaces Referring now to FIGS. 3, 4 and 5, there is shown one preferred embodiment of the present invention where the triangular universal mounting unit 10 open use position sides 2 and 5 may be hidden in a closed position, with closed position side 1 exposed, when not in use to prevent the present invention from interfering with other objects in the vehicle or with occupants when the mounting sides 2 and 5 of the triangular universal mounting unit 10 are not in use.

More particularly FIG. 3 shows a partial perspective view of a vehicle interior panel 20 having a triangular universal mounting unit 10 mounted in a interior panel cavity 21 showing only the triangular universal mounting unit 10 closed side 1.

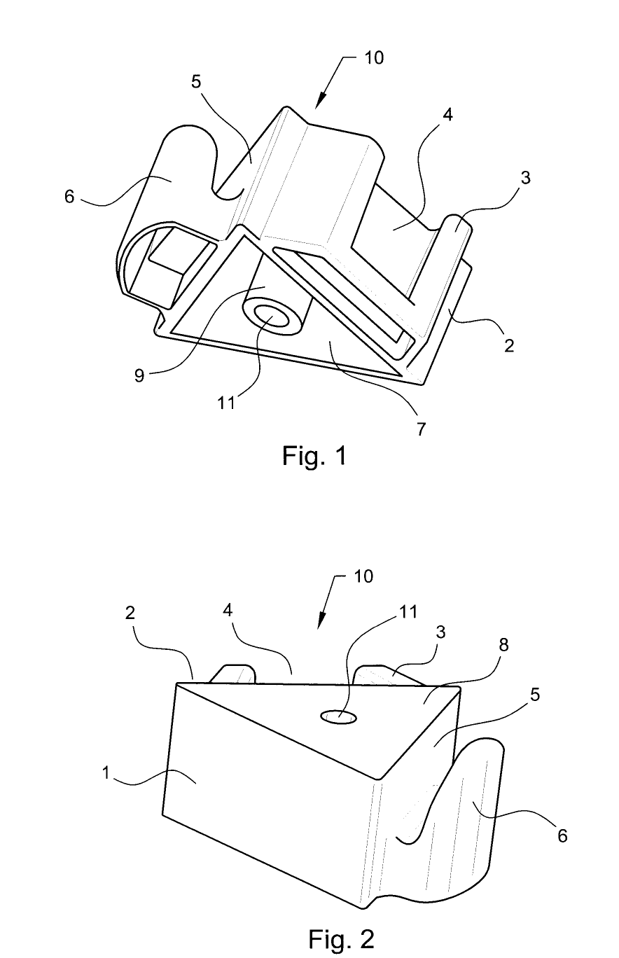

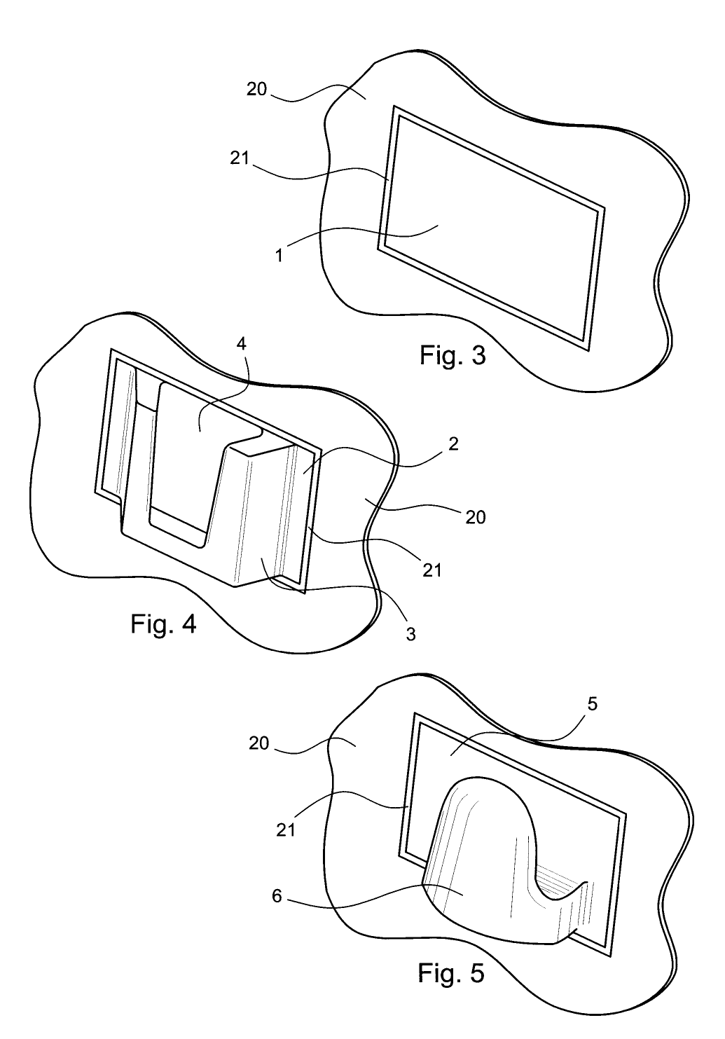

FIG. 4 show a partial perspective view of a vehicle interior panel 20 having a mounting cavity 21 with triangular universal mounting unit 10 mounted therein where the open use position side 2 having a mounting section 3 containing vertical mounting cavity 4 is in the fully open use position.

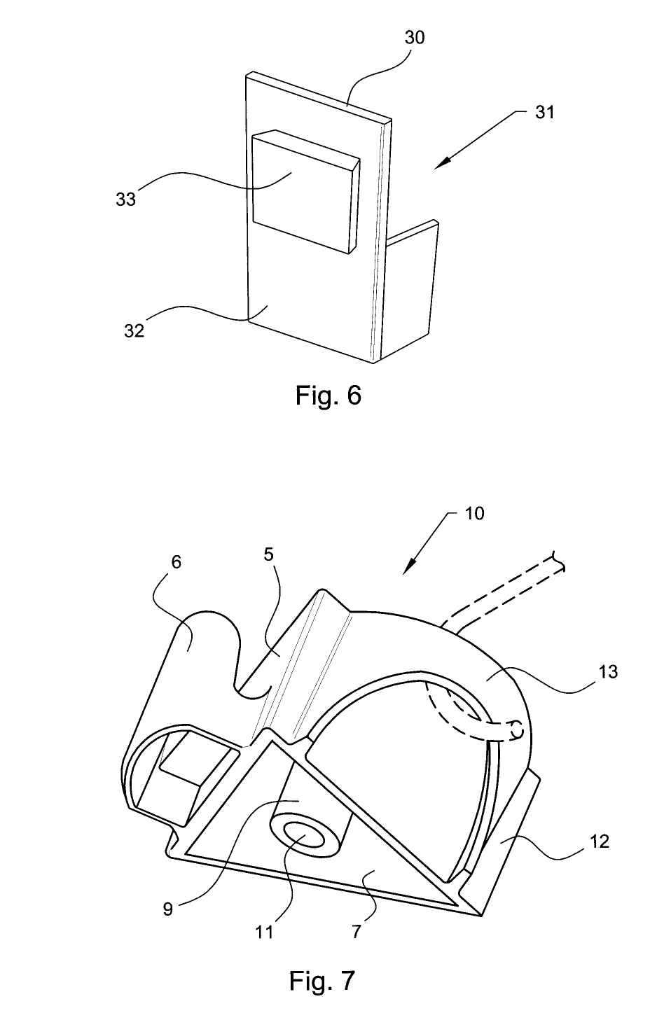

In FIG. 5 there is shown a partial perspective view of a vehicle interior panel 20 with triangular universal mounting unit 10 mounted therein where the open use position side 5 having a hook 6 is in the fully open use position.

In FIG. 6 there is shown a perspective view of one embodiment of a mounting unit of the present invention having a storage receptacle 30 having a device storage side 31 and a mounting side 32, said mounting side 32 having at least one corresponding mounting prongs 33 of a desired shape and size to be received and held by the at least one complimentary vertical mounting cavities 4 (FIGS. 1, 2, 4). The storage receptacle 30 may have storage side 31 with any desired shape and size to accommodate a variety of occupant devices such as cell phones, beverage containers, CDs and DVDs for example. The in-vehicle attachment system of the present invention may be incorporated into the vehicle, with multiple locations, including the seat back panel, instrument panel, door panel, quarter panel, floor panel, or other interior surfaces.

Finally in FIG. 7 there is shown a bottom perspective view of a preferred embodiment the present invention comprising a triangular universal mount unit 10, preferably formed of a molded plastic, and having a closed position side 1 (FIG. 2), an open use position side 12 having a mounting loop section 13 suitable for attaching an elastic cord, and a second open use position side 5 having a hook unit 6, an open face 7 and a closed face 8 (FIG. 2).

It is to be understood that reference to storage receptacle 30 throughout the specification is meant to encompass brackets for mounting items such as, for example, cell phone mounts and CD player mounts; items with the mounting prong 33 as part of their design such as, for example, flash lights; and containers to hold items and articles such as, for example, ice chests, toolboxes, CD bins and the like.

It is also to be understood that the use of the terms “panel” and “floor” is used to encompass not only those specific areas of the interior of a vehicle but in fact any surface capable of having the present invention mounted within it and able to have a concealed closed position therein.

The triangular universal mounting unit 10 and the storage receptacle 5 may be made from any suitable material well known in the art. Preferred materials are polypropylene, reinforced polypropylene, ABS, polycarbonate, polycarbonate/ABS, nylon, and polyacetal. It is to be further understood that the triangular universal mounting unit 10 and the storage receptacle 5 may be made from the same or different materials suitable for the particular application. For example the triangular universal mounting unit 10 may be made from metals such as, for example, aluminum, steel, and other metals to provide greater strength for applications that may require it.

Although the preferred embodiments of the present invention has been disclosed, various changes and modifications may be made without departing from the scope of the invention as set forth in the appended claims.

1. A device mounting apparatus suitable for attaching and securing items and receptacles having various sizes and shapes in a vehicle comprising in cooperative combination:
a triangular mounting unit rotatably movable around a center pivot installed in one of an interior panel, interior surface, and a floor panel of a vehicle having located thereon on a first side a surface complimentary to said interior panel, interior surface, and floor panel, said triangular universal mounting unit having located on at least one other side a mounting cavity;
storage receptacles, items, and brackets having located thereon at least one prong suitable for inserting into said at least one mounting cavity of said triangular universal mounting unit;
thereby allowing the secure attachment of at least one of a desired container, item, and bracket in a vehicle.

2. The invention as claimed in claim 1 wherein, there is a plurality of mounting cavities on each of two sides of said triangular mounting unit.

3. The invention as claimed in claim 1 wherein, there is a mounting cavity on one face of said triangular mounting unit and a hook on another face of said triangular mounting unit.

4. The invention as claimed in claim 1 wherein, said apparatus comprise a plastic.

5. The invention as claimed in claim 4 wherein, said plastic is selected from the group consisting of polypropylene, reinforced polypropylene, ABS, polycarbonate, polycarbonate/ABS, nylon, and polyacetal.

6. The invention as claimed in claim 1 wherein, said apparatus opens and closes by rotating around a center pivot pin.

7. The invention as claimed in claim 1 wherein, said at least one mounting cavity and said corresponding at least one prong are oriented vertically.

8. The invention as claimed in claim 1 wherein, said at least one mounting cavity and said corresponding at least one prong are oriented horizontally.

9. The invention as claimed in claim 1 wherein, there is a mounting loop on one face of said triangular mounting unit and a hook on another face of said triangular mounting unit.

10. A device mounting apparatus suitable for attaching and securing items and receptacles having various sizes and shapes in a vehicle comprising in cooperative combination:
a triangular mounting unit rotatably movable around a center pivot installed in one of an interior panel, interior surface, and a floor panel of a vehicle having located thereon on a first side a surface complimentary to said interior panel, interior surface, and floor panel, said triangular universal mounting unit having located on a second side a mounting cavity and on a third side a hook;
storage receptacles, items, and brackets having located thereon at least one prong suitable for inserting into said at least one mounting cavity of said triangular universal mounting unit;
thereby allowing the secure attachment of at least one of a desired container, item, and bracket in a vehicle by use of either a mounting prong corresponding to said mounting cavity or by use of said hook.

11. The invention as claimed in claim 10 wherein, there are a plurality of mounting cavities and a corresponding number of a plurality of corresponding prongs.

12. The invention as claimed in claim 10 wherein, said apparatus comprise a plastic.

13. The invention as claimed in claim 12 wherein, said plastic is selected from the group consisting of polypropylene, reinforced polypropylene, ABS, polycarbonate, polycarbonate/ABS, nylon, and polyacetal.

14. The invention as claimed in claim 10 wherein, said apparatus opens and closes by pivoting around a pivot pin.

15. The invention as claimed in claim 10 wherein, said mounting cavity and said corresponding prong are oriented vertically.

16. The invention as claimed in claim 10 wherein, said mounting cavity and said corresponding prong are oriented horizontally.

17. The invention as claimed in claim 10 wherein, there is a mounting cavity on one face of said triangular mounting unit and one hook on another face of said triangular mounting unit.
